(19) United States
(12) Patent Application Publication
(10) Pub. No.: US 2026/0148699 A1
(43) Pub. Date: May 28, 2026

(54) DISPLAY APPARATUS AND DRIVING METHOD THEREOF

(71) Applicant: LG Display Co., Ltd., Seoul (KR)

(72) Inventors: Seung Hwan SHIN, Paju-si (KR); Yong Hwa PARK, Paju-si (KR); Dae Seok OH, Paju-si (KR)

(73) Assignee: LG Display Co., Ltd., Seoul (KR)

(21) Appl. No.: 19/360,844

(22) Filed: Oct. 16, 2025

(30) Foreign Application Priority Data
Nov. 26, 2024 (KR) 10-2024-0171360

(51) Int. Cl. G09G 3/3266; G09G 3/3275

(52) U.S. Cl. CPC G09G 3/3266; G09G 3/3275; G09G 2310/0245; G09G 2310/08; G09G 2330/021

(57) ABSTRACT

A display apparatus can include a display panel having a first screen block and a second screen block, a first gate driving circuit for supplying a scan output to first gate lines of the first screen block, and a second gate driving circuit for supplying a scan output to second gate lines of the second screen block. The first screen block includes a first high frequency region where first image data is updated at a first refresh rate, and a first low frequency region where second image data is updated at a second refresh rate less than the first refresh rate. The second screen block includes a second high frequency region where third image data is updated at a third refresh rate, and a second low frequency region where fourth image data is updated at a fourth refresh rate less than the third refresh rate.

### CROSS-REFERENCE TO RELATED APPLICATIONS

This application claims priority to Korean Patent Application No. 10-2024-0171360, filed in the Republic of Korea on November 26, 2024, which is hereby incorporated by reference as if fully set forth herein.

### BACKGROUND

### FIELD

The present disclosure relates to a display apparatus and a driving method thereof, and more particularly, for example, without limitation, to a display apparatus and a driving method thereof, capable of reducing power consumption.

### Discussion of the Related Art

Display apparatuses are being used in various technology fields such as portable terminals, home televisions (TVs), outdoor industry/advertisement displays, and automotive displays. As the display apparatuses increase in screen size and increase in resolution, power-saving technology for stable power supply is an important issue.

The description provided in the background section should not be assumed to be prior art merely because it is mentioned in or associated with the background section. The background section can include information that describes one or more aspects of the subject technology.

### SUMMARY OF THE DISCLOSURE

It is newly recognized by inventors of the present application that, related art power-saving technology may control an entire screen through a same method without considering video content, and due to this, has a limitation in reducing power consumption.

To overcome or address the aforementioned and other limitations of the related art, the present disclosure can provide a display apparatus and a driving method thereof which can drive a plurality of divided screen blocks at independent data refresh rates, based on video content.

Another aspect of the present disclosure is to provide a display apparatus and a driving method thereof capable of reducing power consumption.

Additional advantages, aspects, and features of the disclosure will be set forth in part in the description which follows and in part will become apparent to those having ordinary skill in the art upon examination of the following or can be learned from practice of the disclosure. The aspects and other advantages of the disclosure can be realized and attained by the structure particularly pointed out in the written description and claims hereof as well as the appended drawings.

To achieve these objects and other aspects and in accordance with the purpose of the disclosure, as embodied and broadly described herein, a display apparatus can include: a display panel including a first screen block and a second screen block; a first gate driving circuit configured to supply a scan output to first gate lines of the first screen block; and a second gate driving circuit configured to supply a scan output to second gate lines of the second screen block, wherein the first screen block includes a first high frequency region where first image data is updated at a first data refresh rate and a first low frequency region where second image data is updated at a second data refresh rate which is less than the first data refresh rate, and the second screen block includes a second high frequency region where third image data is updated at a third data refresh rate and a second low frequency region where fourth image data is updated at a fourth data refresh rate which is less than the third data refresh rate.

In another aspect of the present disclosure, a driving method of a display apparatus including a first screen block and a second screen block, can include: supplying a scan output to first gate lines of the first screen block; and supplying a scan output to second gate lines of the second screen block, wherein the first screen block comprises a first high frequency region where first image data is updated at a first data refresh rate and a first low frequency region where second image data is updated at a second data refresh rate which is less than the first data refresh rate, and wherein the second screen block comprises a second high frequency region where third image data is updated at a third data refresh rate and a second low frequency region where fourth image data is updated at a fourth data refresh rate which is less than the third data refresh rate.

According to example embodiments of the present disclosure, the display apparatus and the driving method thereof can drive a plurality of divided screen blocks at independent data refresh rates, based on video content.

According to example embodiments of the present disclosure, the display apparatus and the driving method thereof can further reduce power consumption compared with the conventional power-saving technology.

It is to be understood that both the foregoing general description and the following detailed description of the present disclosure are examples and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the various principles of the disclosure. In the drawings:

FIG. 1 is a diagram illustrating a display apparatus according to an example embodiment of the present disclosure;

FIG. 2 is a diagram illustrating an equivalent circuit of a pixel of a display apparatus according to an example embodiment of the present disclosure;

FIG. 3A is a diagram illustrating an example driving waveform of a pixel in a refresh frame;

FIG. 3B is a diagram illustrating an example driving waveform of a pixel in a skip frame;

FIG. 4 is a diagram illustrating an example where a plurality of screen blocks are driven at independent refresh rates;

FIGS. 5 and 6 are diagrams illustrating a case where a data refresh operation is skipped in synchronization with a scan output masking timing so as to implement multi refresh rate driving of FIG. 4;

FIGS. 7 and 8 are diagrams illustrating a driving waveform and a stage connection configuration of a gate driving circuit masking a scan output from a time at which a masked scan clock is input;

FIGS. 9 and 10 are diagrams illustrating a driving waveform and a circuit configuration of a fifth gate stage where scan output masking starts;

FIGS. 11A to 11D are diagrams illustrating an example operation sequence of a fifth gate stage which implements scan output masking, based on scan clock masking;

FIG. 12 is a diagram illustrating an example configuration of a gate driving circuit which performs scan output masking from a predetermined time, based on a scan clock masking method, and changes a carry transfer direction to a forward direction and a reverse direction;

FIGS. 13A to 13C are diagrams for describing multi refresh rate driving based on forward carry transfer according to an example embodiment of the present disclosure;

FIGS. 14A to 14C are diagrams for describing multi refresh rate driving based on reverse carry transfer according to an example embodiment of the present disclosure;

FIG. 15 is a diagram illustrating extension examples of multi refresh rate driving based on forward and reverse carry transfer; and

FIG. 16 is a diagram illustrating an example connection configuration between a clock masking control circuit, a level shifter, and a gate stage.

Throughout the drawings and the detailed description, unless otherwise described, the same drawing reference numerals should be understood to refer to the same elements, features, and structures. The relative size and depiction of these elements can be exaggerated for clarity, illustration, and convenience.

### DETAILED DESCRIPTION OF THE EMBODIMENTS

Hereinafter, the present disclosure will be described more fully with reference to the accompanying drawings, in which example embodiments of the disclosure are shown. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art. Wherever possible, the same reference numbers will be used throughout the drawings to refer to the same or like parts, unless otherwise specified. The progression of processing steps and/or operations described is an example; however, the sequence of steps and/or operations is not limited to that set forth herein and can be changed as is known in the art, with the exception of steps and/or operations necessarily occurring in a particular order. Like reference numerals designate like elements throughout. Names of the respective elements used in the following explanations can be selected only for convenience of writing the specification and can be thus different from those used in actual products.

Advantages and features of the present disclosure, and implementation methods thereof will be clarified through following embodiments described with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. Furthermore, the present disclosure is only defined by scopes of claims.

Furthermore, in the following detailed description of the present disclosure, numerous specific details are set forth in order to provide a sufficiently thorough understanding of the present disclosure. However, it will be understood that the present disclosure can be practiced without these specific details. In other instances, known methods, procedures, components, and circuits have not been described in detail so as not to unnecessarily obscure aspects of the present disclosure.

The shapes, sizes, ratios, angles, numbers and the like disclosed in the drawings for description of various embodiments of the present disclosure to describe embodiments of the present disclosure are merely examples and the present disclosure is not limited thereto. Like reference numerals refer to like elements throughout. Throughout this specification, the same elements are denoted by the same reference numerals. As used herein, the terms “comprise”, “having,” “including” and the like suggest that other parts can be added unless a more limiting term, such as “only” is used. As used herein, the singular forms "a", "an", and "the" are intended to include the plural forms as well, unless context clearly indicates otherwise. Any implementation described herein as an “example” is not necessarily to be construed as preferred or advantageous over other implementations.

Elements in various embodiments of the present disclosure are to be interpreted as including margins of error even without explicit statements.

Where positional relationships are described, for example, where the positional relationship between two parts is described using “on,” “over,” “under,” “above,” “below,” “beneath,” “near,” “close to,” or “adjacent to,” “beside,” “next to,” or the like, one or more other parts can be disposed between the two parts unless a more limiting term, such as “immediate(ly),” “direct(ly),” or “close(ly)” is used. For example, when a structure is described as being positioned “on,” “over,” “under,” “above,” “below,” “beneath,” “near,” “close to,” or “adjacent to,” “beside,” or “next to” another structure, this description should be construed as including a case in which the structures contact each other as well as a case in which a third structure is disposed or interposed therebetween. Furthermore, the terms “left,” “right,” “top,” “bottom, “downward,” “upward,” “upper,” “lower,” and the like refer to an arbitrary frame of reference.

In describing a temporal relationship, when the temporal order is described as, for example, “after,” “subsequent,” “next,” and “before,” a case that is not continuous can be included unless a more limiting term, such as “just,” “immediate(ly),” or “direct(ly)” is used.

Where an element or layer is referred to as being “on” or “connected to” another element or layer, it should be understood to mean that the element or layer can be directly on or directly connected to the other element or layer, or that intervening elements or layers can be present. Also, where one element is referred to as being disposed “on” or “under” another element, it should be understood to mean that the elements can be so disposed to directly contact each other, or can be so disposed without directly contacting each other.

The term “at least one” should be understood as including any and all combinations of one or more of the associated listed items. For example, the meaning of “at least one of a first element, a second element, and a third element” encompasses the combination of all three listed elements, combinations of any two of the three elements, as well as each individual element, the first element, the second element, or the third element.

It will be understood that, although the terms such as “first”, “second”, “A”, “B”, “(a)”, “(b)” etc. can be used herein to describe various elements, these elements should not be limited by these terms. These terms are only used to distinguish one element from another, and do not limit the essence, sequence, order, or number of the elements. For example, a first element could be termed a second element, and, similarly, a second element could be termed a first element, without departing from the scope of the present disclosure. Further, the term “can” fully encompasses all the meanings and coverages of the term “may” and vice versa.

In the following description, when the detailed description of the relevant known function or configuration is determined to unnecessarily obscure the important point of the present disclosure, the detailed description will be omitted. Hereinafter, embodiments of the present disclosure will be described in detail with reference to the accompanying drawings.

Features of various embodiments of the present disclosure can be partially or overall coupled to or combined with each other, and can be variously inter-operated with each other and driven technically as those skilled in the art can sufficiently understand. The embodiments of the present disclosure can be carried out independently from each other, or can be carried out together in a co-dependent relationship.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning for example consistent with their meaning in the context of the relevant art and should not be interpreted in an idealized or overly formal sense unless expressly so defined herein. For example, the term “part” or “unit” can apply, for example, to a separate circuit or structure, an integrated circuit, a computational block of a circuit device, or any structure configured to perform a described function as should be understood to one of ordinary skill in the art.

Hereinafter, embodiments of the present disclosure will be described in detail with reference to the accompanying drawings. Further, all the components of each display apparatus according to all embodiments of the present disclosure are operatively coupled and configured. For convenience of description, a scale of each of elements illustrated in the accompanying drawings differs from a real scale, and thus, is not limited to a scale illustrated in the drawings.

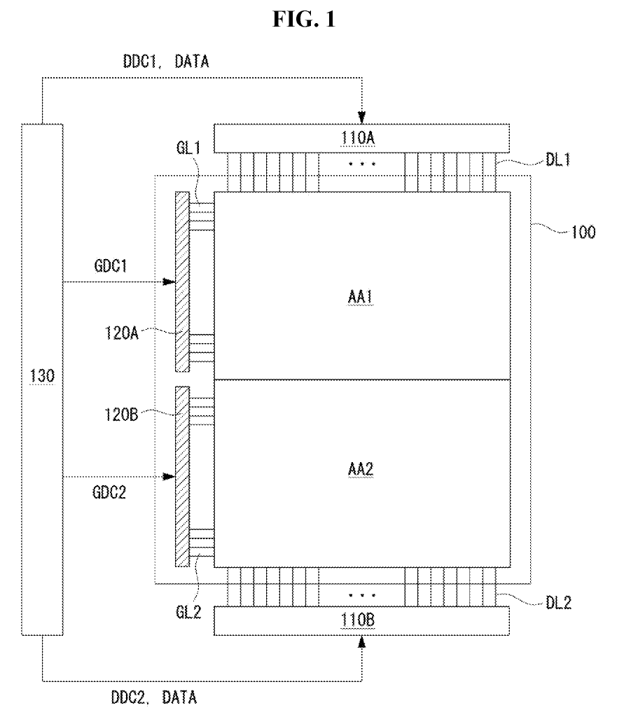

FIG. 1 is a diagram illustrating a display apparatus according to an embodiment of the present disclosure.

Referring to FIG. 1, the display apparatus according to an embodiment of the present disclosure can be described by way of an organic light emitting display apparatus, but the present disclosure is not limited thereto, and the display apparatus of the present disclosure can also be implemented as a quantum dot display apparatus, a micro light emitting diode (LED) display apparatus or a mini light emitting diode (LED) display apparatus. A display panel 100 can include a screen which reproduces an input image. The screen can include a pixel array which displays pixel data (hereinafter referred to as "image data") DATA of an input image.

The screen can at least include a first screen block AA1 and a second screen block AA2, which are divisionally driven. The first screen block AA1 and the second screen block AA2 can be electrically disconnected or separated from each other. One side of the first screen block AA1 and one side of the second screen block AA2 can contact each other with a boundary therebetween. A first data driving circuit 110A can be disposed at the other side, which is opposite to the one side, of the first screen block AA1. A second data driving circuit 110B can be disposed at the other side, which is opposite to the one side, of the second screen block AA2. The screen block of the present disclosure can also be referred to as display region block or display driving block, and the present disclosure is not limited thereto.

The first screen block AA1 can include first data lines DL1, first gate lines GL1 intersecting the first data lines DL1, and first pixels. The first pixels can be arranged in the first screen block AA1 in a matrix type defined by intersections between the first data lines DL1 and the first gate lines GL1 to configure a first pixel array. The first pixels can be arranged as various types such as a stripe type and a diamond type in the first screen block AA1, based on positions of the first pixels emitting lights of the same color.

The second screen block AA2 can include second data lines DL2, second gate lines GL2 intersecting the second data lines DL2, and second pixels. The second pixels can be arranged in the second screen block AA2 in a matrix type defined by intersections between the second data lines DL2 and the second gate lines GL2 to configure a second pixel array. The second pixels can be arranged as various types such as a stripe type and a diamond type in the second screen block AA2, based on positions of the second pixels emitting lights of the same color.

The first screen block AA1 and the second screen block AA2 may not share the data lines DL1 and DL2, and moreover, may not share the gate lines GL1 and GL2. The first data lines DL1 disposed in the first screen block AA1 and the second data lines DL2 disposed in the second screen block AA2 can be physically and electrically disconnected from each other. Also, the first gate lines GL1 disposed in the first screen block AA1 and the second gate lines GL2 disposed in the second screen block AA2 can be physically and electrically disconnected from each other.

Pixels PIX included in the first screen block AA1 and the second screen block AA2 can include an R pixel which generates red (R) light, a G pixel which generates green (G) light, and a B pixel which generates blue (B) light, for various color combinations. The pixels PIX can further include a W pixel which generates white (W) light. The RGB pixels or the RGBW pixels can configure one unit pixel.

Each of the pixels included in the first screen block AA1 and the second screen block AA2 can be implemented with a pixel circuit which is connected to a data line DL and a gate line GL through a thin film transistor (TFT). The pixel circuit can include a light emitting device, a driving transistor, one or more switch transistors, and a capacitor. The light emitting device can be implemented as an organic light emitting diode (OLED) where an organic compound layer is disposed between a cathode electrode and an anode electrode. A driving current applied to the light emitting device can be controlled based on a gate-source voltage of the driving transistor. The gate-source voltage of the driving transistor can be determined by a data voltage corresponding to image data DATA.

The pixel circuit can sample a threshold voltage of the driving transistor in the middle of a pixel programming operation which is performed in one frame period and can allow a sampled threshold voltage to be reflected in a gate-source voltage (hereinafter referred to as Vgs) of the driving transistor, and thus, can prevent or reduce a driving current from being distorted due to a threshold voltage variation of the driving transistor. In other words, the threshold voltage variation of the driving transistor can be reflected and thus compensated in the gate-source voltage of the driving transistor, thereby the driving current would not be affected by such threshold voltage variation.

The pixel circuit can be implemented as a hybrid type. In a hybrid-type pixel circuit, semiconductor layers of some transistors can include low-temperature polycrystalline silicon (hereinafter referred to as LTPS), and semiconductor layers of the other transistors can include oxide semiconductor.

The timing controller 130 can receive video data DATA and a timing signal, synchronized with the video data DATA, from a host system. The timing signal can include a vertical synchronization signal Vsync, a horizontal synchronization signal Hsync, a clock signal DCLK, and a data enable signal DE. The vertical synchronization signal Vsync can define a vertical period (i.e., one frame period). The horizontal synchronization signal Hsync can define a horizontal period (i.e., one frame period). The data enable signal DE can define a time where the video data DATA is transferred, in a vertical period or a horizontal period.

The timing controller 130 can generate a first source timing control signal DDC1 for controlling an operation timing of a first data driving circuit 110A and a first gate timing control signal GDC1 for controlling an operation timing of a first gate driving circuit 120A, based on the timing signals Vsync, Hsync, and DE received from the host system.

The timing controller 130 can generate a second source timing control signal DDC2 for controlling an operation timing of a second data driving circuit 110B and a second gate timing control signal GDC2 for controlling an operation timing of a second gate driving circuit 120B, based on the timing signals Vsync, Hsync, and DE received from the host system.

The display panel driving circuit can be connected to the timing controller 130 through an interface circuit.

The display panel driving circuit can include a first data driving circuit 110A and a first gate driving circuit 120A for driving the first screen block AA1 and a second data driving circuit 110B and a second gate driving circuit 120B for driving the second screen block AA2.

The first data driving circuit 110A can drive first data lines DL1 of the first screen block AA1, and the first gate driving circuit 120A can drive first gate lines GL1 of the first screen block AA1. The second data driving circuit 110B can drive second data lines DL2 of the second screen block AA2, and the second gate driving circuit 120B can drive second gate lines GL2 of the second screen block AA2.

The first data driving circuit 110A can be implemented with a plurality of driving integrated circuits (ICs). The first data driving circuit 110A can be supplied with image data DATA and the first source timing control signal DDC1 from the timing controller 130. The first data driving circuit 110A can generate first data voltages corresponding to the image data DATA and can output the first data voltages to the first data lines DL1, based on the first source timing control signal DDC1.

The second data driving circuit 110B can be implemented with a plurality of driving ICs. The second data driving circuit 110B can be supplied with image data DATA and the second source timing control signal DDC2 from the timing controller 130. The second data driving circuit 110B can generate second data voltages corresponding to the image data DATA and can output the second data voltages to the second data lines DL2, based on the second source timing control signal DDC2.

The first gate driving circuit 120A and the second gate driving circuit 120B can be directly formed in a bezel region outside the screen blocks AA1 and AA2 of the display panel 100. The screen blocks AA1 and AA2 can be included in a display area of the display panel 100, and the first gate driving circuit 120A and the second gate driving circuit 120B can be disposed in the bezel region or non-display region adjacent to the display area of the display panel 100.

The first gate driving circuit 120A can generate first gate signals of a pulse type, based on the first gate timing control signal GDC1 supplied from the timing controller 130, and can output the first gate signals to the first gate lines GL1 (e.g., through line progressive scanning). The first gate signals of a pulse type can include one or more scan signals and an emission control signal.

The second gate driving circuit 120B can generate second gate signals of a pulse type, based on the second gate timing control signal GDC2 supplied from the timing controller 130, and can output the second gate signals to the second gate lines GL2 (e.g., through line progressive scanning). The second gate signals of a pulse type can include one or more scan signals and an emission control signal.

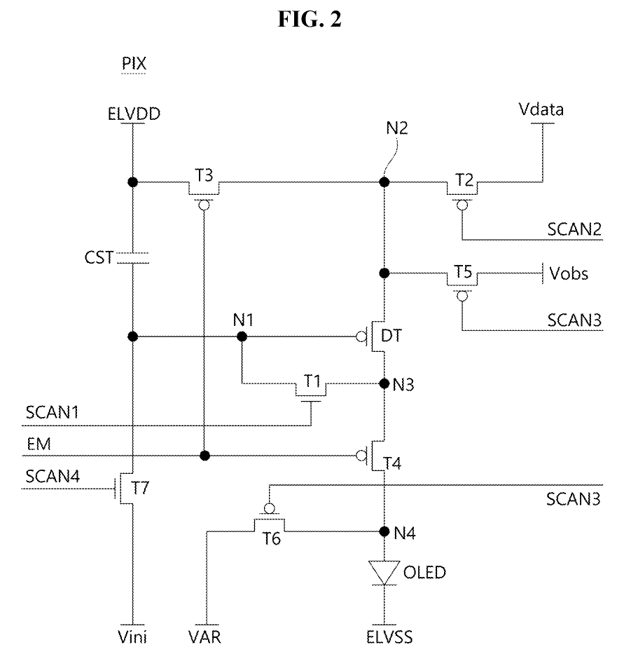

FIG. 2 is a diagram illustrating an equivalent circuit of a pixel PIX of a display apparatus according to an embodiment of the present disclosure. For instance, the configuration of FIG. 2 can be the configuration of each pixel PX of the display apparatus of FIG. 1 or other display apparatuses according to examples of the present disclosure.

Referring to FIG. 2, the pixel PIX can be implemented with a pixel circuit which includes a light emitting device OLED, a driving transistor DT, a plurality of switch transistors (for example, first to seventh switch transistors) T1 to T7, and a capacitor CST.

The driving transistor DT, the switch transistors T1 to T7, and the capacitor CST can control a driving current flowing in the light emitting device OLED to drive the light emitting device OLED. Each of the driving transistor DT and the switch transistors T1 to T7 can include a first electrode, a second electrode, and a gate electrode. One of the first electrode and the second electrode can be a source electrode, and the other of the first electrode and the second electrode can be a drain electrode.

Each of the second to sixth transistors T2 to T6 and the driving transistor DT can be implemented as a PMOS type including a semiconductor layer having LTPS, which is good in response characteristic. On the other hand, the first and seventh transistors T1 and T7 directly connected to a gate electrode of the driving transistor DT can be implemented as an NMOS type including an oxide semiconductor layer which is good in off characteristic.

An on level voltage of the PMOS-type transistor can be a gate low voltage, and an off level voltage of the PMOS-type transistor can be a gate high voltage. On the other hand, an on level voltage of the NMOS-type transistor can be a gate high voltage, and an off level voltage of the NMOS-type transistor can be a gate low voltage.

The light emitting device OLED can include an anode electrode (or a pixel electrode), a cathode electrode (or a common electrode), and an organic compound layer (configured with a common layer and an emission layer) disposed therebetween. The anode electrode of the light emitting device OLED can be connected to a fourth node N4, and the cathode electrode of the light emitting device OLED can be connected to a second source voltage ELVSS.

The driving transistor DT can include a gate electrode connected to the first node N1, a source electrode connected to a second node N2, and a drain electrode connected to a third node N3. The driving transistor DT can generate the driving current based on a voltage of the first node N1 (or a data voltage stored in the capacitor CST) and can apply the driving current to the light emitting device OLED.

The first switch transistor T1 can include a gate electrode receiving a first scan signal SCAN1, a drain electrode connected to the third node N3, and a source electrode connected to the first node N1. The first switch transistor T1 can be turned on in response to the first scan signal SCAN1 and can short-circuit the gate electrode and the drain electrode of the driving transistor DT with each other. Accordingly, the driving transistor DT can operate like a diode while the first switch transistor T1 is being turned on.

The second switch transistor T2 can include a gate electrode receiving a second scan signal SCAN2, a source electrode receiving a data voltage Vdata, and a drain electrode connected to the second node N2. The second switch transistor T2 can be turned on in response to the second scan signal SCAN2 and can transfer the data voltage Vdata to the second node N2.

The capacitor CST can be connected between the first node N1 and an input terminal of a first source voltage ELVDD. The capacitor CST can hold a voltage of the first node N1.

The third and fourth switch transistors T3 and T4 can be connected between the first source voltage ELVDD and the light emitting diode OLED and can form a current movement path through which the driving current generated by the driving transistor DT moves.

The third switch transistor T3 can include a source electrode connected to the input terminal of the first source voltage ELVDD, a drain electrode connected to the second node N2, and a gate electrode which receives an emission control signal EM. The fourth switch transistor T4 can include a source electrode connected to the third node N3, a drain electrode connected to the fourth node N4, and a gate electrode which receives the emission control signal EM.

The third and fourth switch transistors T3 and T4 can be turned on in response to the emission control signal EM. While the third and fourth switch transistors T3 and T4 are being turned on, the light emitting device OLED can receive the driving current from the driving transistor DT and can emit light with brightness corresponding to the driving current.

The fifth switch transistor T5 can include a source electrode connected to an input terminal of an OBS voltage Vobs, a drain electrode connected to the second node N2, and a gate electrode which receives a third scan signal SCAN3. The fifth switch transistor T5 can be turned on in response to the third scan signal SCAN3 and can apply the OBS voltage Vobs to the second node N2.

The sixth switch transistor T6 can include a source electrode connected to an input terminal of an anode reset voltage VAR, a drain electrode connected to the fourth node N4, and a gate electrode which receives the third scan signal SCAN3. The sixth switch transistor T6 can be turned on in response to the third scan signal SCAN3 and can transfer the anode reset voltage VAR to the fourth node N4.

The seventh switch transistor T7 can include a source electrode connected to an input terminal of an initialization voltage Vini, a drain electrode connected to the first node N1, and a gate electrode which receives a fourth scan signal SCAN4. The seventh switch transistor T7 can be turned on in response to the fourth scan signal SCAN4 and can apply the initialization voltage Vini to the first node N1.

The pixel circuit can be driven at multi refresh rates. For multi refresh rate driving, a data refresh operation can be skipped in synchronization with a scan output masking timing. One or more skip frames during which the data refresh operation is skipped can be provided between adjacent refresh frames. A refresh rate can be determined based on the number of skip frames.

The pixel circuit can perform a data refresh operation including pixel initialization and data programming in a refresh frame. The light emitting device can be turned off when performing a data refresh operation, and at this time, an anode reset operation where the light emitting device is initialized into an anode reset voltage can be performed.

The pixel circuit can omit (or skip) a data refresh operation in a skip frame, and a data refresh condition Vgs (the driving current) which is set in a preceding refresh frame can be intactly maintained. The pixel circuit can perform an anode reset operation for turning off the light emitting device in the skip frame. Accordingly, a time length where the light emitting device is turned on in the skip frame can be substantially equal to a time length where the light emitting device is turned on in the refresh frame.

In each of the refresh frame and the skip frame, while the anode reset operation is being performed, the pixel circuit can perform an on-bias stress (OBS) operation on the driving transistor. The OBS operation can be for preventing or reducing an image quality defect which can be caused by a hysteresis characteristic of the driving transistor.

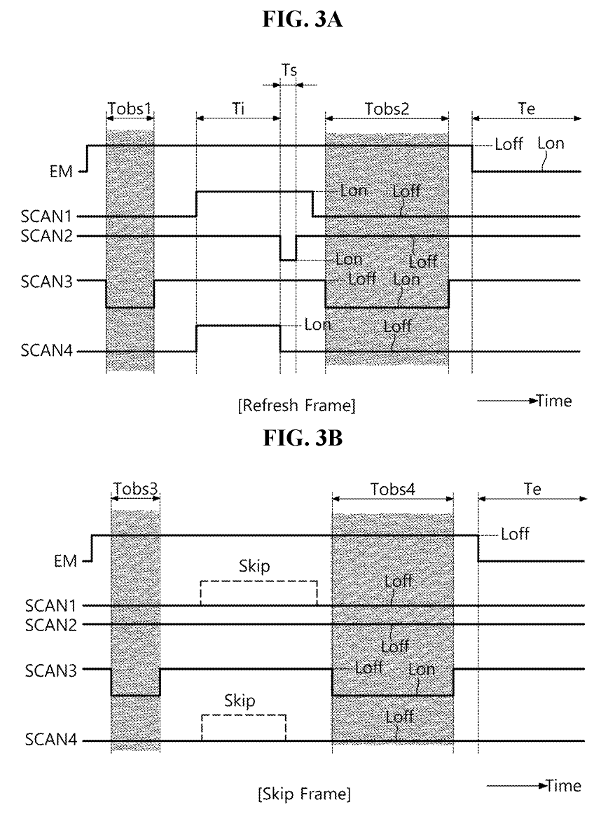

FIG. 3A is a diagram illustrating a driving waveform of a pixel in a refresh frame.

Referring to FIG. 3A a first OBS period Tobs1, an initialization period Ti, a programming period Ts, a second OBS period Tobs2, and an emission period Te can be time-serially arranged in the refresh frame.

A second scan signal SCAN2 can define the programming period Ts where a data voltage Vdata is supplied. The programming period Ts can be an on level (Lon) period of the second scan signal SCAN2.

A third scan signal SCAN3 can define a first OBS period Tobs1 preceding the programming period Ts and a second OBS period Tobs2 succeeding the programming period Ts and preceding the emission period Te. The first OBS period Tobs1 and the second OBS period Tobs2 can each be an on level (Lon) period of the third scan signal SCAN3.

A fourth scan signal SCAN4 can define an initialization period Ti which is arranged between the first OBS period Tobs1 and the programming period Ts. The initialization period Ti can be an on level (Lon) period of the fourth scan signal SCAN4.

An emission control signal EM can define an emission period Te succeeding the second OBS period Tobs2. The emission period Te can be an on level (Lon) period of the emission control signal EM.

In the first OBS period Tobs1, the OBS voltage Vobs can be applied to the second node N2. Based on the OBS voltage Vobs, a drain-source channel of the driving transistor DT can be maximally opened, and the driving transistor DT can maintain a stronger saturation state, and thus, a hysteresis characteristic of the driving transistor DT can be recovered prior to data programming.

In the first OBS period Tobs1, the anode reset voltage Var can be applied to the fourth node N4, and thus, residual electric charges charged in a parasitic capacitor formed between the anode electrode and the cathode electrode of the light emitting device OLED can be reset.

In the initialization period Ti, the first node N1 can be initialized into the initialization voltage Vini, and as the first switch transistor T1 is turned on, the driving transistor DT can operate like a diode.

In the programming period Ts, as the first and second switch transistors T1 and T2 are turned on, a threshold voltage sampling operation and a data programming operation can be sequentially or simultaneously performed.

In the second OBS period Tobs2, the OBS voltage Vobs can be applied to the second node N2. Based on the OBS voltage Vobs, a drain-source channel of the driving transistor DT can be maximally opened, and the driving transistor DT can maintain a stronger saturation state, and thus, a hysteresis characteristic of the driving transistor DT can be re-recovered prior to the emission of light.

In the second OBS period Tobs2, the anode reset voltage VAR can be applied to the fourth node N4, and thus, residual electric charges charged in a parasitic capacitor of the light emitting device OLED can be re-reset.

In the emission period Te, a driving current can be supplied from the driving transistor DT to the light emitting device OLED. The driving current can be based on Vgs of the driving transistor DT set in the programming period Ts. The driving current can be irrelevant to a threshold voltage of the driving transistor DT and can be associated with the data voltage Vdata.

FIG. 3B is a diagram illustrating a driving waveform of a pixel in a skip frame.

Referring to FIG. 3B, a third OBS period Tobs3, a fourth OBS period Tobs4, and an emission period Te can be time-serially arranged in the skip frame.

The emission control signal EM can define the emission period Te of the skip frame. The emission period Te can be an on level (Lon) period of the emission control signal EM. The on level (Lon) period of the emission control signal EM in the skip frame can be substantially the same as the refresh frame.

The third scan signal SCAN3 can further define the third OBS period Tobs3 and the fourth OBS period Tobs4 which are sequentially arranged before the emission period Te, in the skip frame. In the skip frame, the third OBS period Tobs3 and the fourth OBS period Tobs4 can each be an on level (Lon) period of the third scan signal SCAN3. The on level (Lon) period of the third scan signal SCAN3 in the skip frame can be substantially the same as the refresh frame.

Furthermore, the initialization period and the programming period may not be needed in the skip frame.

To this end, in the skip frame, an output of the first scan signal SCAN1 and an output of the fourth scan signal SCAN4 can be skipped. In addition, the output of the third scan signal SCAN3 can be skipped.

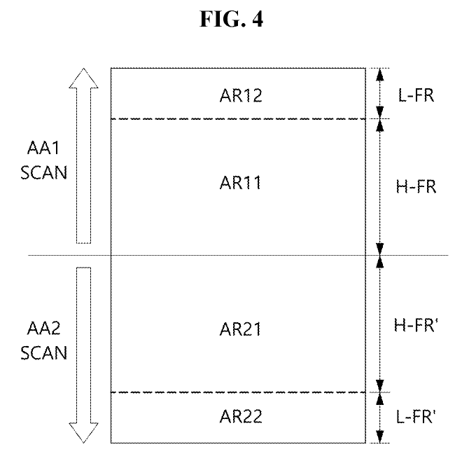

FIG. 4 is a diagram illustrating an example where a plurality of screen blocks are driven at independent refresh rates.

Referring to FIG. 4, one screen can be divided into a first screen block AA1 and a second screen block AA2, which are independently driven.

The first screen block AA1 can be driven based on a first scan output and image data corresponding thereto.

The first screen block AA1 can include a first high frequency region AR11 where first image data is updated at a first data refresh rate H-FR and a first low frequency region AR12 where second image data is updated at a second data refresh rate L-FR which is less than the first data refresh rate H-FR.

In the same frame, depending on the scan direction of the first screen block AA1, a scan output timing corresponding to gate lines of the first high frequency region AR11 can be earlier than a scan output timing corresponding to gate lines of the first low frequency region AR12, but the present disclosure is not limited thereto. Furthermore, in a predetermined time, the number of scan output maskings on the gate lines of the first low frequency region AR12 can be more than the number of scan output maskings on the gate lines of the first high frequency region AR11.

The second screen block AA2 can be driven based on a second scan output and image data corresponding thereto.

The second screen block AA2 can include a second high frequency region AR21 where third image data is updated at a third data refresh rate H-FR' and a second low frequency region AR22 where fourth image data is updated at a fourth data refresh rate L-FR' which is less than the third data refresh rate H-FR'.

In the same frame, depending on the scan direction of the first screen block AA1, a scan output timing corresponding to gate lines of the second high frequency region AR21 can be earlier than a scan output timing corresponding to gate lines of the second low frequency region AR22, but the present disclosure is not limited thereto. Furthermore, in a predetermined time, the number of scan output maskings on the gate lines of the second low frequency region AR22 can be more than the number of scan output maskings on the gate lines of the second high frequency region AR21.

Meanwhile, the first data refresh rate H-FR and the third data refresh rate H-FR' can be equal to or different from each other. Also, the second data refresh rate L-FR and the fourth data refresh rate L-FR' can be equal to or different from each other.

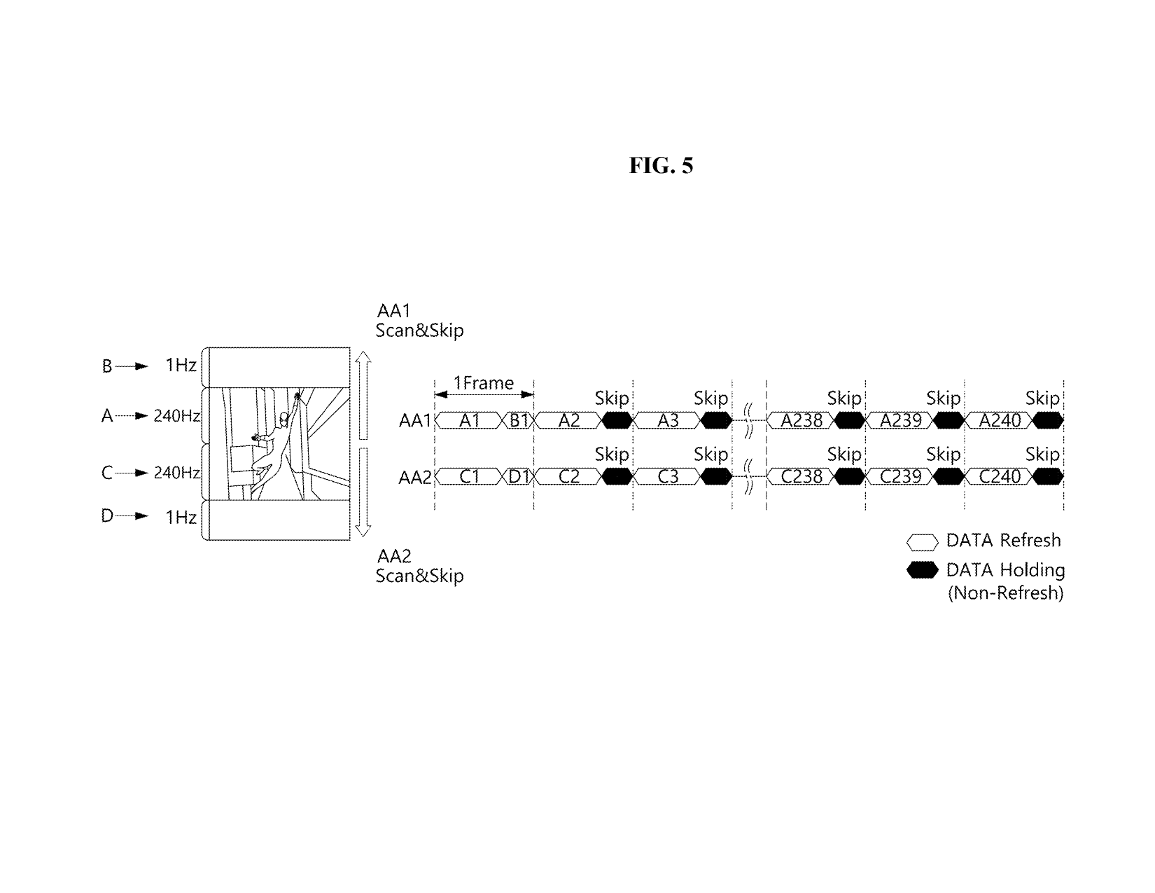

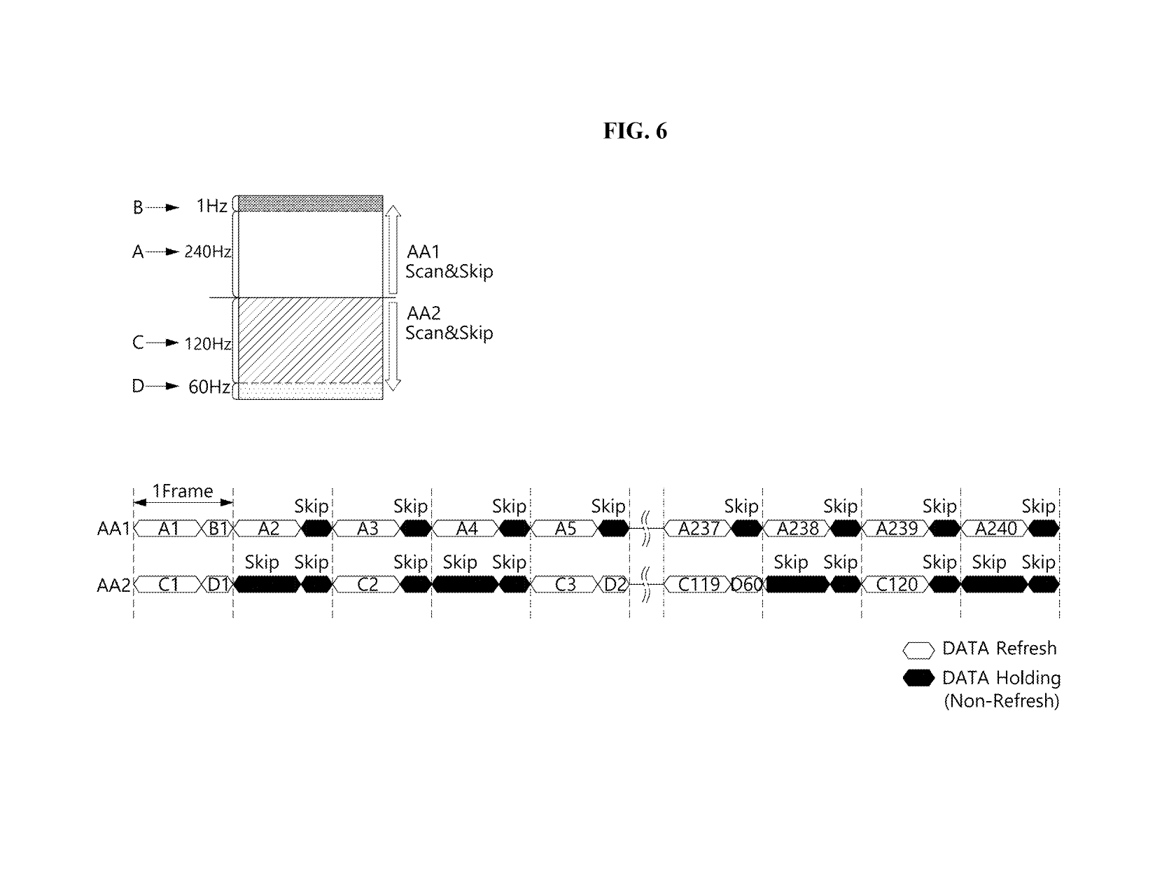

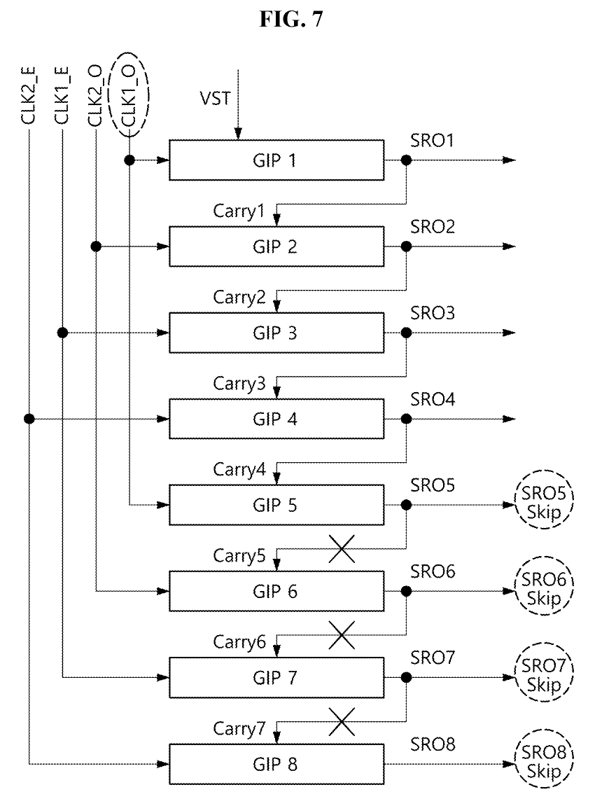

FIGS. 5 and 6 are diagrams illustrating a case where a data refresh operation is skipped in synchronization with a scan output masking timing so as to implement multi refresh rate driving of FIG. 4.

Referring to FIG. 5, a first high frequency region AR11 of a first screen block AA1 can update first image data A at a period of 240 Hz, and a first low frequency region AR12 of the first screen block AA1 can update second image data B at a period of 1 Hz. A refresh operation on the first high frequency region AR11 can be synchronized with a scan output timing in each of first to 240^{th} frames. On the other hand, a refresh operation on the first low frequency region AR12 can be synchronized with a scan output timing in the first frame, and then, can be omitted in synchronization with scan output masking timings in the second to 240^{th} frames. The first high frequency region AR11 can be a region of interest (ROI), and the first low frequency region AR12 can be a background region.

Referring to FIG. 5, a second high frequency region AR21 of a second screen block AA2 can update third image data C at a period of 240 Hz, and a second low frequency region AR22 of the second screen block AA2 can update fourth image data D at a period of 1 Hz. A refresh operation on the second high frequency region AR21 can be synchronized with a scan output timing in each of first to 240^{th} frames. On the other hand, a refresh operation on the second low frequency region AR22 can be synchronized with a scan output timing in the first frame, and then, can be omitted in synchronization with scan output masking timings in the second to 240^{th} frames. The second high frequency region AR21 can be an ROI, and the second low frequency region AR22 can be a background region.

Referring to FIG. 6, a first high frequency region AR11 of a first screen block AA1 can update first image data A at a period of 240 Hz, and a first low frequency region AR12 of the first screen block AA1 can update second image data B at a period of 1 Hz. A refresh operation on the first high frequency region AR11 can be synchronized with a scan output timing in each of first to 240^{th} frames. On the other hand, a refresh operation on the first low frequency region AR12 can be synchronized with a scan output timing in the first frame, and then, can be omitted in synchronization with scan output masking timings in the second to 240^{th} frames. The first high frequency region AR11 can be a region of interest (ROI), and the first low frequency region AR12 can be a background region.

Referring to FIG. 6, a second high frequency region AR21 of a second screen block AA2 can update third image data C at a period of 120 Hz, and a second low frequency region AR22 of the second screen block AA2 can update fourth image data D at a period of 60 Hz. A refresh operation on the second high frequency region AR21 can be synchronized with a scan output timing in each of first to 120^{th} odd frames and can be synchronized with scan output masking timings in the other frames (for example, even frames). On the other hand, a refresh operation on the second low frequency region AR22 can be synchronized with a scan output timing in each of (4k-3)^{th} (where k can be 1 to 60) frames and can be omitted in synchronization with scan output masking timings in the other frames. It is to be noted that the refresh rates of 240 Hz, 120 Hz, 60 Hz and 1Hz are described only by way of example, and other possible refresh rates can also be implemented in the present disclosure.

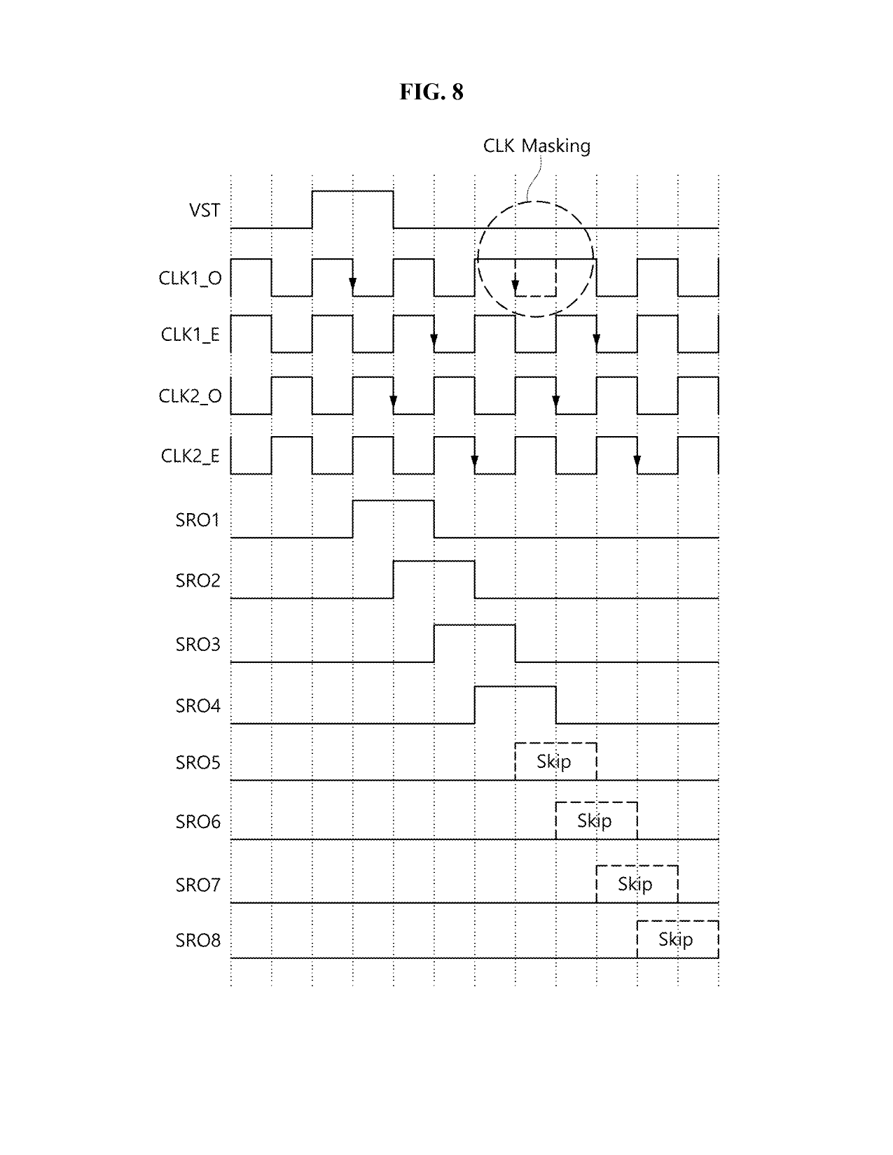

FIGS. 7 and 8 are diagrams illustrating a driving waveform and a stage connection configuration of a gate driving circuit masking a scan output from a time at which a masked scan clock is input.

The gate driving circuit of FIG. 7 can be each of the first gate driving circuit 120A and the second gate driving circuit 120B of FIG. 1. For example, each of the first gate driving circuit 120A and the second gate driving circuit 120B of FIG. 1 can be implemented as in FIG. 7.

Referring to FIGS. 7 and 8, the gate driving circuit can include a plurality of gate stages GIP1 to GIP8 which are connected to each other in cascade.

The gate driving circuit can include (4k-3)^{th} (where k can be a positive integer) gate stages GIP1 and GIP5 which generate a scan output corresponding to a first odd clock CLK1_O, (4k-2)^{th} gate stages GIP2 and GIP6 which generate a scan output corresponding to a second odd clock CLK2_O having a phase which differs from that of the first odd clock CLK1_O, (4k-1)^{th} gate stages GIP3 and GIP7 which generate a scan output corresponding to a first even clock CLK1_E having the same phase as that of the first odd clock CLK1_O, and 4k^{th} gate stages GIP4 and GIP8 which generate a scan output corresponding to a second even clock CLK2_E having the same phase as that of the second odd clock CLK2_O. As can be seen from FIG. 8, a phase difference between the first odd clock CLK1_O and the second odd clock CLK2_O is 180 degrees, and a phase difference between the first even clock CLK1_E and the second even clock CLK2_E is 180 degrees. In other words, the phases of the first odd clock CLK1_O and the second odd clock CLK2_O are opposite to each other, and the phases of the first even clock CLK1_E and the second even clock CLK2_E are also opposite to each other.

The GIP1 can be enabled in operation, based on a start signal VST input from the outside, and can generate a scan output SRO1 corresponding to the first odd clock CLK1_O. The scan output SRO1 of the GIP1 can be input as a first carry signal Carry 1 to the GIP2. The GIP2 can be enabled in operation, based on the first carry signal Carry 1, and can generate a scan output SRO2 corresponding to the second odd clock CLK2_O. In this manner, a scan output SRO7 of the GIP7 can be input as a seventh carry signal Carry 7 to the GIP8. The GIP8 can be enabled in operation, based on the seventh carry signal Carry 7, and can generate a scan output SRO8 corresponding to the second even clock CLK2_E.

On the other hand, when the first odd clock CLK1_O is input in a masked state in synchronization with a scan output SRO5 timing of the GIP5, scan outputs SRO5 to SRO8 of the GIP5 to GIP8 can be skipped. The scan output SRO5 of the GIP5 can be skipped by a masked first odd clock CLK1_O, and the scan outputs SRO6, SRO7, and SRO8 of the GIP6, GIP7, and GIP8 can be skipped by carry signals Carry 5, Carry 6, and Carry 7 of an off level.

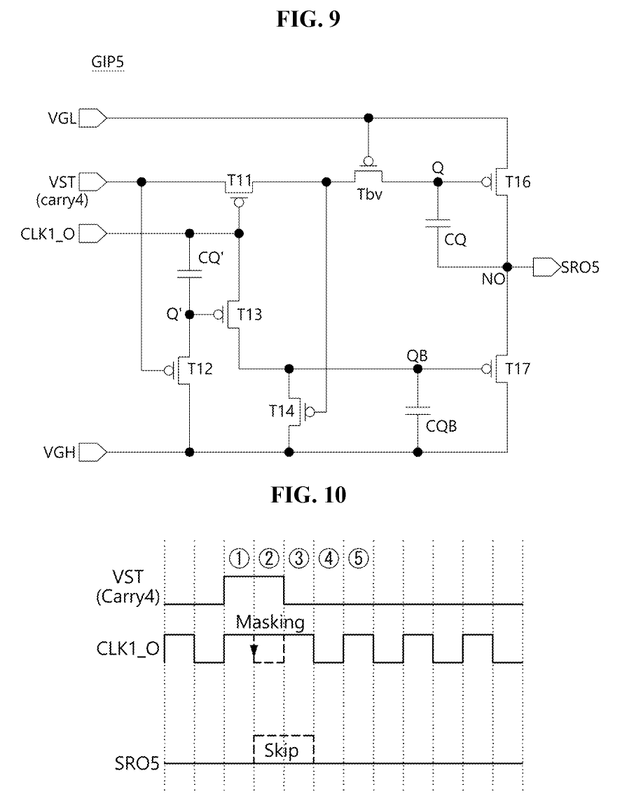

FIG. 9 is a diagram illustrating a circuit configuration of a fifth gate stage GIP5 where scan output masking starts.

Referring to FIG. 9, the fifth gate stage GIP5 can include elements such as T11, T12, T13, T14, Tbv, T16, T17, CQ, CQB, and CQ'. Each of the T11, T12, T13, T14, Tbv, T16, and T17 can be implemented as a PMOS transistor, but the present disclosure is not limited thereto.

The T16 can be a first output buffer (a pull-down buffer). A gate of the T16 can be connected to a Q node, a source thereof can be connected to a gate low voltage VGL, and a drain thereof can be connected to an output node NO.

The T17 can be a second output buffer (a pull-up buffer). A gate of the T17 can be connected to a QB node, a source thereof can be connected to the output node NO, and a drain thereof can be connected to a gate high voltage VGH.

A gate of the T11 can be connected to an input of a first odd clock CLK1_O, a source thereof can be connected to an input of Carry 4, and a drain thereof can be connected to a source of the Tbv.

A gate of the T12 can be connected to the input of the Carry 4, a source thereof can be connected to a Q' node, and a drain thereof can be connected to the gate high voltage VGH.

A gate of the T13 can be connected to the Q' node, a source thereof can be connected to the input of the first odd clock CLK1_O, and a drain thereof can be connected to the QB node.

A gate of the T14 can be connected to the input of the Carry 4, a source thereof can be connected to the QB node, and a drain thereof can be connected to the gate high voltage VGH.

A gate of the Tbv can be connected to a gate on voltage VGL, a source thereof can be connected to the drain of the T11, and a drain thereof can be connected to the Q node. In addition, each of the CQ, CQB, and CQ' can be implemented as capacitors, and the CQ can be connected between the Q node and the output node NO, the CQB can be connected between the QB node and the gate high voltage VGH, and the CQ' can be connected between the Q' node and the CQ' node.

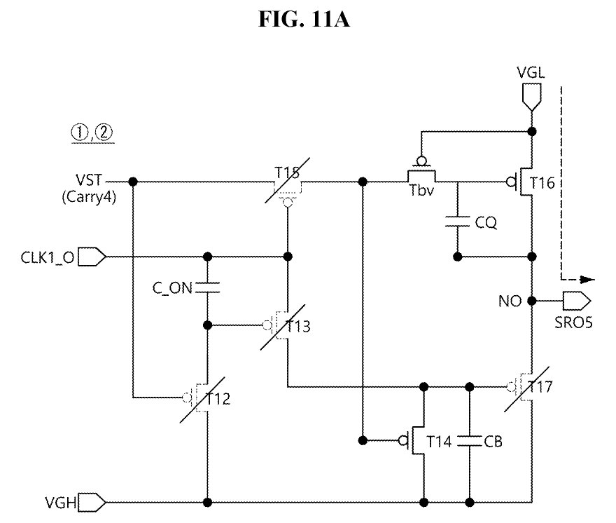

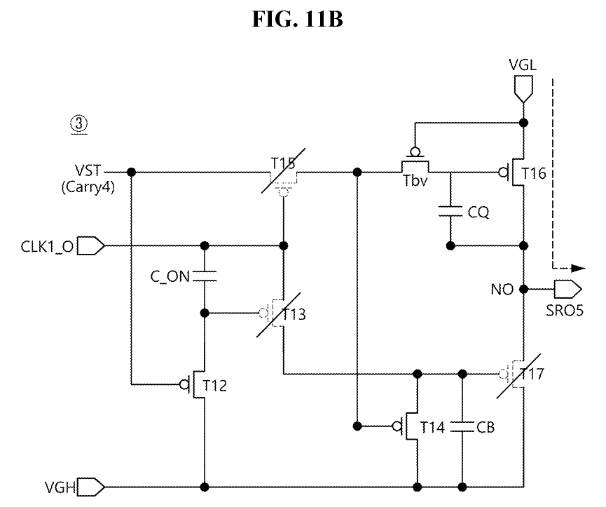

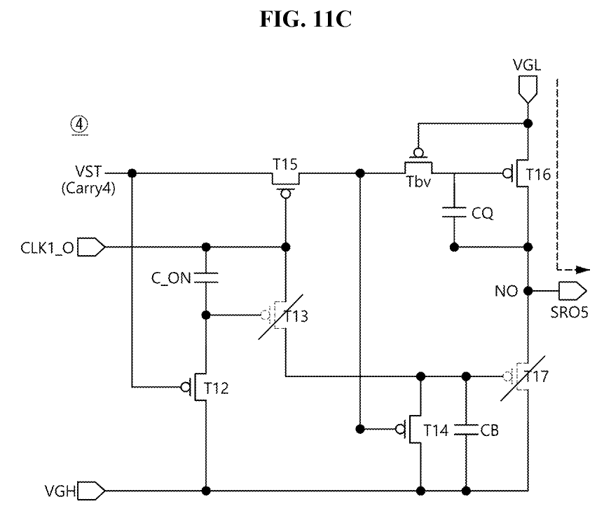

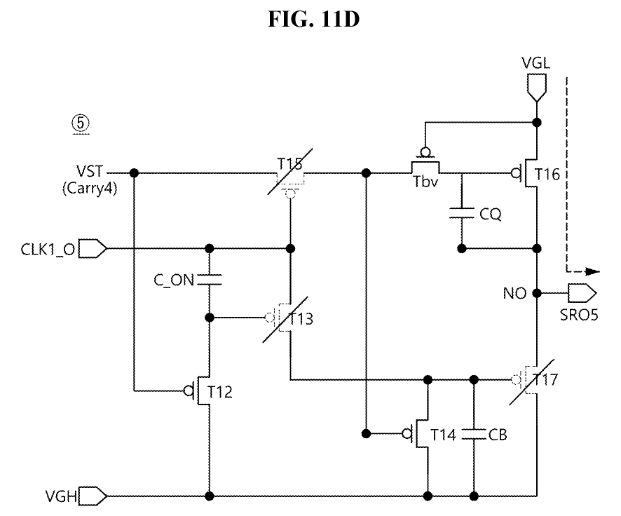

FIG. 10 is a diagram illustrating an operation waveform of a fifth gate stage where scan output masking starts. FIGS. 11A to 11D are diagrams illustrating an operation sequence of a fifth gate stage which implements scan output masking, based on scan clock masking;

Referring to FIGS. 10 and 11A, in ① and ② periods, T12, T13, T11, and T17 can be turned off, and T14, Tbv, and T16 can be turned on. In the ① and ② periods, a scan output SRO5 can be a gate low voltage VGL.

Referring to FIGS. 10 and 11B, in a ③ period, the T13, T11, and T17 can be turned off, and the T12, T14, Tbv, and T16 can be turned on. In the ③ period, the scan output SRO5 can be the gate low voltage VGL.

Referring to FIGS. 10 and 11C, in a ④ period, the T13 and T17 can be turned off, and the T12, T14, T11, Tbv, and T16 can be turned on. In the ④ period, the scan output SRO5 can be the gate low voltage VGL.

Referring to FIGS. 10 and 11D, in a ⑤ period, the T13, T11, and T17 can be turned off, and the T12, T14, Tbv, and T16 can be turned on. In the ⑤ period, the scan output SRO5 can be the gate low voltage VGL.

As a result, in ② and ③ periods, the scan output SRO5 can be output as the gate low voltage VGL, based on masking of the first odd clock CLK1_O. In other words, in the ② and ③ periods, the scan output SRO5 may not be output as a gate high voltage VGH and can be masked to be the gate low voltage VGL.

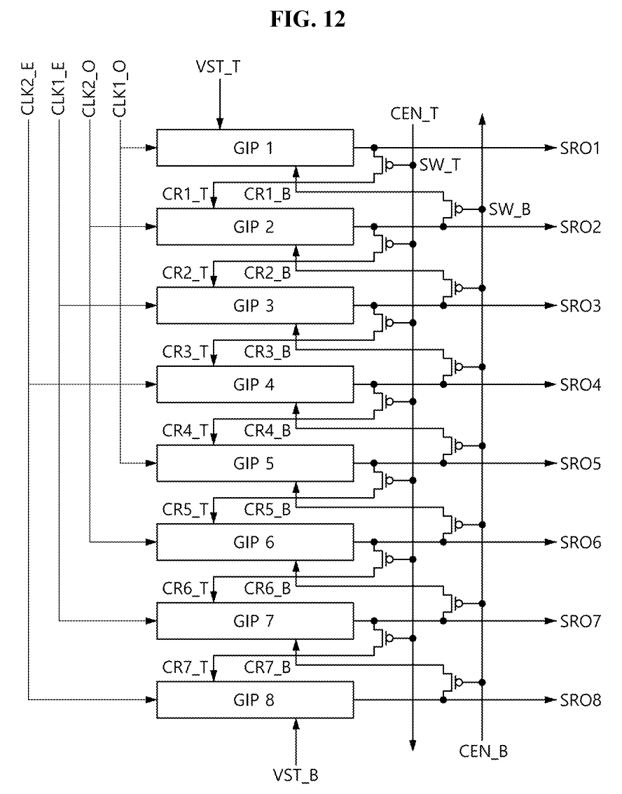

FIG. 12 is a diagram illustrating a configuration of a gate driving circuit which performs scan output masking from a predetermined time, based on a scan clock masking method, and changes a carry transfer direction to a forward direction and a reverse direction.

The gate driving circuit of FIG. 12 can be each of the first gate driving circuit 120A and the second gate driving circuit 120B of FIG. 1. For example, each of the first gate driving circuit 120A and the second gate driving circuit 120B of FIG. 1 can be implemented as in FIG. 12.

Referring to FIG. 12, the gate driving circuit can include a plurality of gate stages GIP1 to GIP8 which are connected to each other in cascade.

The gate driving circuit can include (4k-3)^{th} (where k can be a positive integer) gate stages GIP1 and GIP5 which generate a scan output corresponding to a first odd clock CLK1_O, (4k-2)^{th} gate stages GIP2 and GIP6 which generate a scan output corresponding to a second odd clock CLK2_O having a phase which differs from that of the first odd clock CLK1_O, (4k-1)^{th} gate stages GIP3 and GIP7 which generate a scan output corresponding to a first even clock CLK1_E having the same phase as that of the first odd clock CLK1_O, and 4k^{th} gate stages GIP4 and GIP8 which generate a scan output corresponding to a second even clock CLK2_E having the same phase as that of the second odd clock CLK2_O.

The gate driving circuit can further include a plurality of first carry transfer switches SW_T which are enabled in only forward carry shift driving. The forward carry shift driving can denote driving where a carry signal is transferred from an upper side to a lower side.

Each of the plurality of first carry transfer switches SW_T can be connected between scan outputs SRO1 and SRO5 of the (4k-3)^{th} gate stages GIP1 and GIP5 and forward carry inputs CR1_T and CR5_T of the (4k-2)^{th} gate stages GIP2 and GIP6.

Each of the plurality of first carry transfer switches SW_T can be connected between scan outputs SRO2 and SRO6 of the (4k-2)^{th} gate stages GIP2 and GIP6 and forward carry inputs CR2_T and CR6_T of the (4k-1)^{th} gate stages GIP3 and GIP7.

Each of the plurality of first carry transfer switches SW_T can be connected between scan outputs SRO3 and SRO7 of the (4k-1)^{th} gate stages GIP3 and GIP7 and forward carry inputs CR3_T and CR7_T of the 4k^{th} gate stages GIP4 and GIP8.

In forward carry shift driving, the GIP1 can be enabled in operation, based on a first start signal VST_T, and can output the scan output SRO1 corresponding to the first odd clock CLK1_O. The scan output SRO1 of the GIP1 can be input as a first forward carry signal CR1_T to the GIP2. The GIP2 can be enabled in operation, based on the first forward carry signal CR1_T, and can generate the scan output SRO2 corresponding to the second odd clock CLK2_O. In this manner, a scan output SRO7 of the GIP7 can be input as a seventh forward carry signal CR7_T to the GIP8. The GIP8 can be enabled in operation, based on the seventh forward carry signal CR7_T, and can generate a scan output SRO8 corresponding to the second even clock CLK2_E.

Moreover, the gate driving circuit can further include a plurality of second carry transfer switches SW_B which are enabled in only reverse carry shift driving. The reverse carry shift driving can denote driving where a carry signal is transferred from a lower side to an upper side.

Each of the plurality of second carry transfer switches SW_B can be connected between scan outputs SRO8 and SRO4 of the 4k^{th} gate stages GIP8 and GIP4 and reverse carry inputs CR7_B and CR3_B of the (4k-1)^{th} gate stages GIP7 and GIP3.

Each of the plurality of second carry transfer switches SW_B can be connected between scan outputs SRO7 and SRO3 of the (4k-1)^{th} gate stages GIP7 and GIP3 and reverse carry inputs CR6_B and CR2_B of the (4k-2)^{th} gate stages GIP6 and GIP2.

Each of the plurality of second carry transfer switches SW_B can be connected between scan outputs SRO6 and SRO2 of the (4k-2)^{th} gate stages GIP6 and GIP2 and reverse carry inputs CR5_B and CR1_B of the (4k-3)^{th} gate stages GIP5 and GIP1.

In reverse carry shift driving, the GIP8 can be enabled in operation, based on a second start signal VST_B, and can output the scan output SRO8 corresponding to the second even clock CLK2_E. The scan output SRO8 of the GIP8 can be input as a seventh reverse carry signal CR7_B to the GIP7. The GIP7 can be enabled in operation, based on the seventh reverse carry signal CR7_B, and can generate the scan output SRO7 corresponding to the first even clock CLK1_E. In this manner, a scan output SRO2 of the GIP2 can be input as a first reverse carry signal CR1_B to the GIP1. The GIP1 can be enabled in operation, based on the first reverse carry signal CR1_B, and can generate a scan output SRO1 corresponding to the first odd clock CLK1_O.

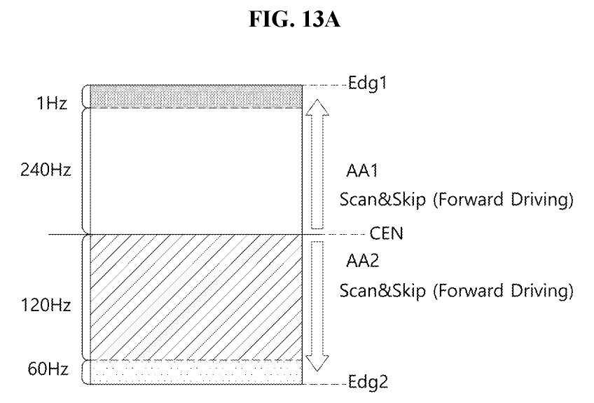

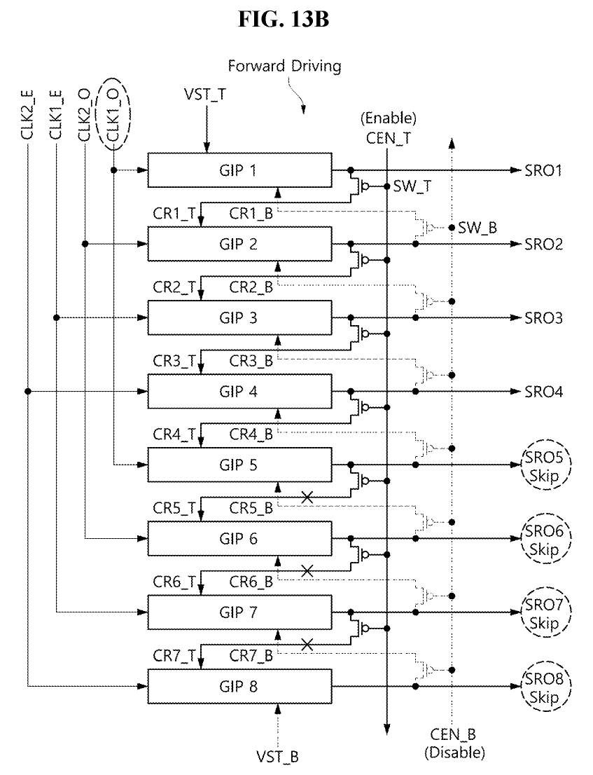

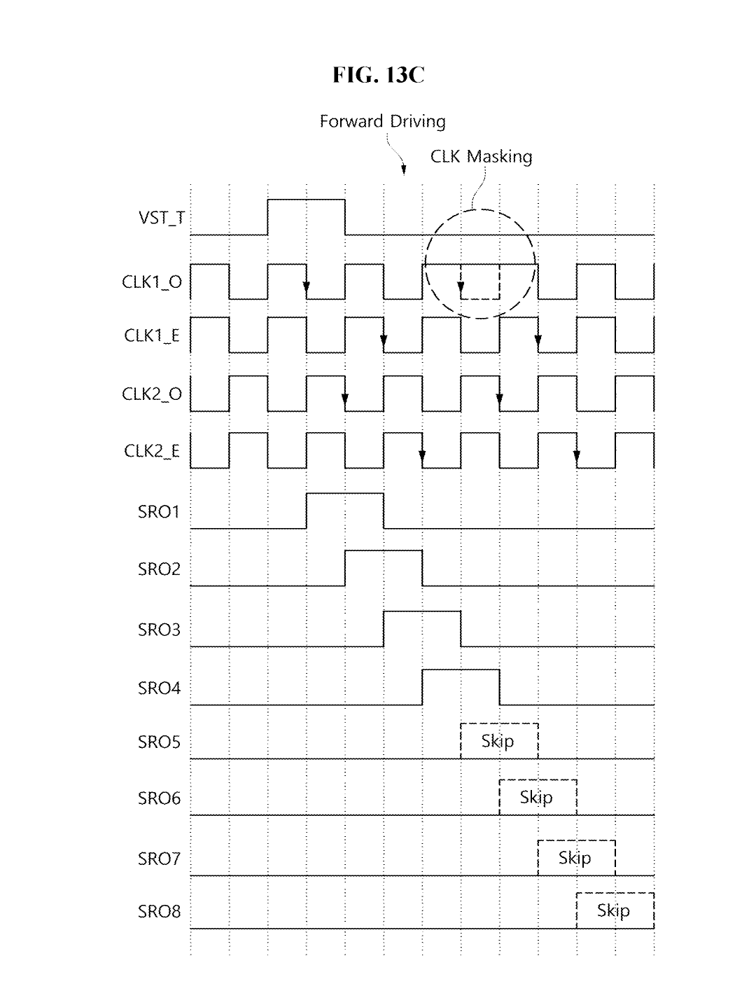

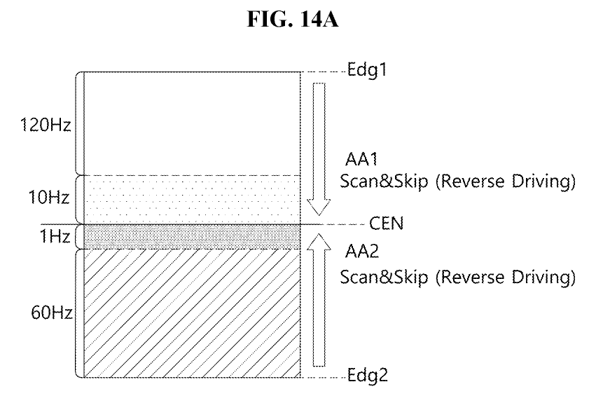

FIGS. 13A to 13C are diagrams for describing multi refresh rate driving based on forward carry transfer.

Referring to FIG. 13A, a first high frequency region of a first screen block AA1 can update first image data at a period of 240 Hz, and a first low frequency region of the first screen block AA1 can update second image data at a period of 1 Hz. To this end, a first gate driving circuit can perform forward carry shift driving to transfer a forward carry signal toward a screen upper side Edg1 from a screen center CEN.

Referring to FIG. 13A, a second high frequency region of a second screen block AA2 can update third image data at a period of 120 Hz, and a second low frequency region of the second screen block AA2 can update fourth image data at a period of 60 Hz. To this end, a second gate driving circuit can perform forward carry shift driving to transfer the forward carry signal toward a screen lower side Edg2 from the screen center CEN.

In the first or second gate driving circuit, when the first odd clock CLK1_O is input in a masked state in synchronization with a scan output SRO5 timing of a GIP5, scan outputs SRO5 to SRO8 of GIP5 to GIP8 can be skipped. The scan output SRO5 of the GIP5 can be skipped by a masked first odd clock CLK1_O, and the scan outputs SRO6, SRO7, and SRO8 of the GIP6, GIP7, and GIP8 can be skipped by CR5_T, CR6_T, and CR7_T of an off level.

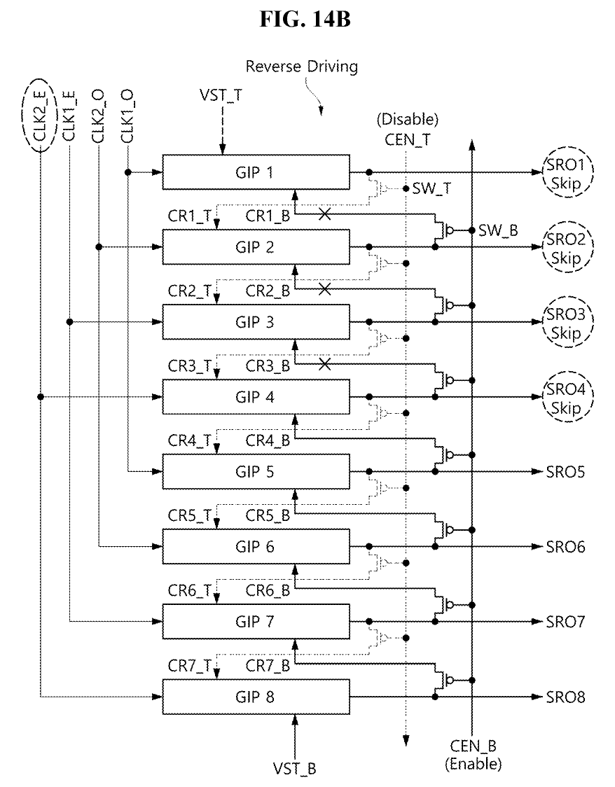

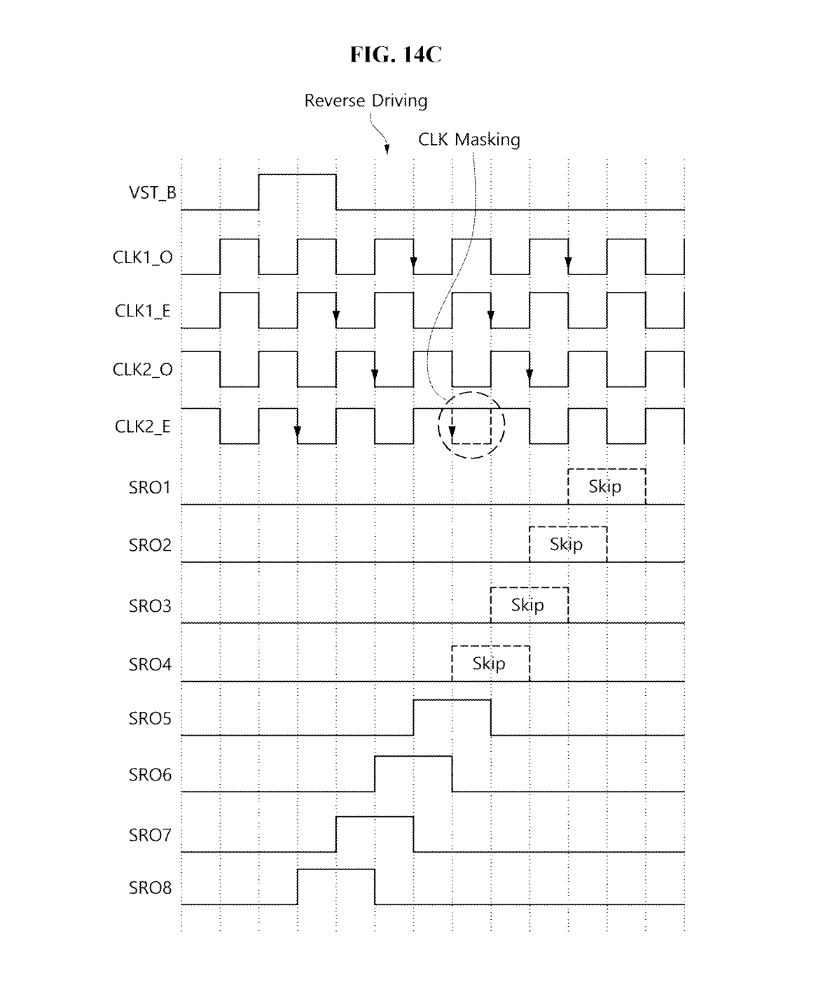

FIGS. 14A to 14C are diagrams for describing multi refresh rate driving based on reverse carry transfer.

Referring to FIG. 14A, a first high frequency region of a first screen block AA1 can update first image data at a period of 120 Hz, and a first low frequency region of the first screen block AA1 can update second image data at a period of 10 Hz. To this end, a first gate driving circuit can perform reverse carry shift driving to transfer a reverse carry signal toward a screen center CEN from a screen upper side Edg1.

Referring to FIG. 14A, a second high frequency region of a second screen block AA2 can update third image data at a period of 60 Hz, and a second low frequency region of the second screen block AA2 can update fourth image data at a period of 1 Hz. To this end, a second gate driving circuit can perform reverse carry shift driving to transfer the reverse carry signal toward the screen center CEN from a screen lower side Edg2.

In the first or second gate driving circuit, when the second even clock CLK2_E is input in a masked state in synchronization with a scan output SRO4 timing of a GIP4, scan outputs SRO4 to SRO1 of GIP4 to GIP1 can be skipped. The scan output SRO4 of the GIP4 can be skipped by a masked second even clock CLK2_E, and the scan outputs SRO3, SRO2, and SRO1 of the GIP3, GIP2, and GIP1 can be skipped by CR3_B, CR2_B, and CR1_B of an off level.

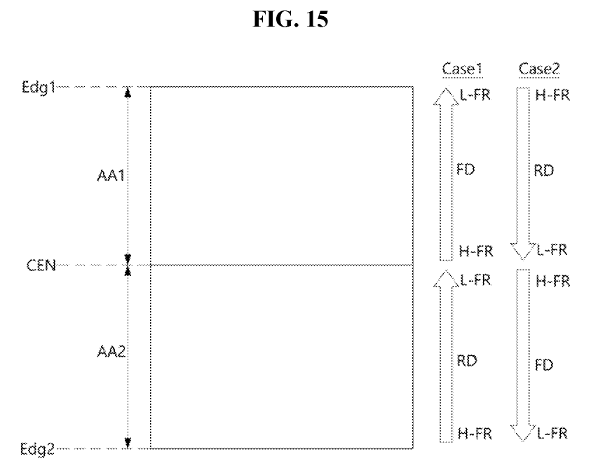

FIG. 15 is a diagram illustrating extension examples of multi refresh rate driving based on forward and reverse carry transfer.

Referring to FIG. 15, a frequency region can be divided from a high frequency to a low frequency with respect to a scan start position of each case.

As in case 1 of FIG. 15, a first gate driving circuit can perform forward carry shift driving to transfer a forward carry signal toward a screen upper side Edg1 of a first screen block AA1 from a screen center CEN of the first screen block AA1, and a second gate driving circuit can perform reverse carry shift driving to transfer a reverse carry signal toward the screen center CEN of the first screen block AA1 from a screen lower side Edg2 of the first screen block AA1.

In case 1, based on scan & skip driving of the first gate driving circuit, a region of the first screen block AA1 close to the screen center CEN can be a high frequency region H-FR, and a region of the first screen block AA1 close to the screen upper side Edg1 can be a low frequency region L-FR.

In case 1, based on scan & skip driving of the second gate driving circuit, a region of the second screen block AA2 close to the screen lower side Edg2 can be the high frequency region H-FR, and a region of the second screen block AA2 close to the screen center CEN can be the low frequency region L-FR.

As in case 2 of FIG. 15, the first gate driving circuit can perform reverse carry shift driving to transfer a reverse carry signal toward the screen center CEN of the first screen block AA1 from the screen upper side Edg1 of the first screen block AA1, and the second gate driving circuit can perform reverse carry shift driving to transfer a forward carry signal toward the screen lower side Edg2 of the second screen block AA2 from the screen center CEN of the second screen block AA2.

In case 2, based on scan & skip driving of the first gate driving circuit, a region of the first screen block AA1 close to the screen upper side Edg1 can be the high frequency region H-FR, and a region of the first screen block AA1 close to the screen center CEN can be the low frequency region L-FR.

In case 2, based on scan & skip driving of the second gate driving circuit, a region of the second screen block AA2 close to the screen center CEN can be the high frequency region H-FR, and a region of the second screen block AA2 close to the screen lower side Edg2 can be the low frequency region L-FR.

It is to be noted that, although it is shown in the drawings that the display region of the display panel is divided into two screen blocks, but the display region of the display panel can also be divided into three or more screen blocks, and the present disclosure is not limited thereto.

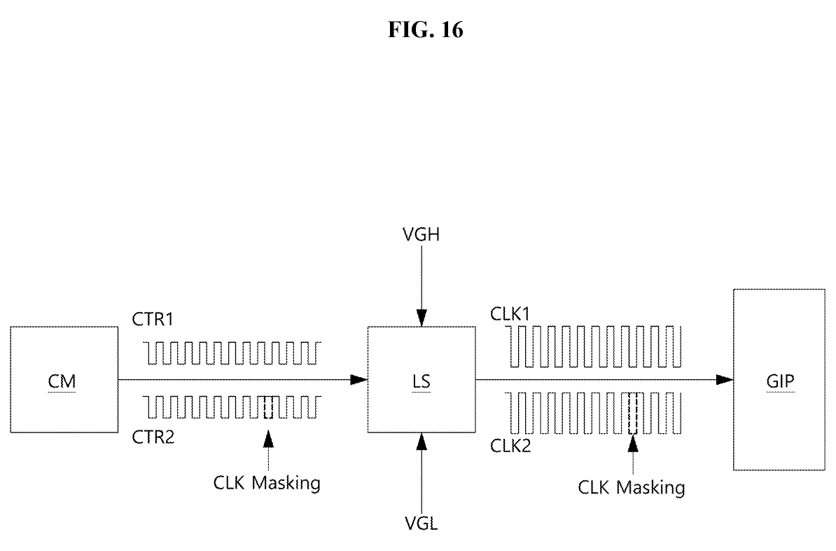

FIG. 16 is a diagram illustrating a connection configuration between a clock masking control circuit, a level shifter, and a gate stage.

Referring to FIG. 16, a clock masking control circuit CM can analyze first image data which is to be input to a first screen block, and thus, can set a region, where the amount of variation of image data is relatively large, to a first high frequency region and can set a region, where the amount of variation of image data is relatively small, to a first low frequency region.

The clock masking control circuit CM can generate a first control signal CTR1 corresponding to a scan output masking timing of the first high frequency region and a second control signal CTR2 corresponding to a scan output masking timing of the first low frequency region. In this case, the frequency number of clock maskings of the second control signal CTR2 can be more than the frequency number of clock maskings of the first control signal CTR1. The first control signal CTR1 may not include a clock masking period, and only the second control signal CTR2 can include the clock masking period.

A level shifter LS can shift the first control signal CTR1 of a transistor to transistor (TTL) level to a boosting level between a gate high voltage VGH and a gate low voltage VGL to generate a first clock signal CLK1. The first clock signal CLK1 can be input to a corresponding gate stage GIP.

The level shifter LS can shift the second control signal CTR2 of a TTL level to the boosting level between the gate high voltage VGH and the gate low voltage VGL to generate a second clock signal CLK2. The second clock signal CLK2 can be input to a corresponding gate stage GIP.

In this case, the frequency number of clock maskings of the second clock signal CLK2 can be more than the frequency number of clock maskings of the first clock signal CLK1. The first clock signal CLK1 may not include the clock masking period, and only the second clock signal CLK2 can include the clock masking period.

The present disclosure can drive divided screen blocks at independent data refresh rates, based on video content. The present disclosure can mask a scan clock at a desired timing to skip a GIP output, and thus, can drive the screen blocks at different data refresh rates. A scan clock masking method according to the present disclosure can divide a frequency region from a high frequency into a low frequency with respect to a scan start position. Because an update of image data stops in a low frequency region, power consumption can decrease in proportion thereto. The present disclosure can independently drive a plurality of screen regions for power saving, based on video content.

The effects according to the present disclosure are not limited to the above examples, and other various effects can be included in the specification.

While the present disclosure has been particularly shown and described with reference to example embodiments thereof, it will be understood by those of ordinary skill in the art that various changes in form and details can be made therein without departing from the technical concept and scope of the present disclosure as defined by the following claims.

What is claimed is:

1. A display apparatus comprising:
a display panel including a first screen block and a second screen block;
a first gate driving circuit configured to supply a scan output to first gate lines of the first screen block; and
a second gate driving circuit configured to supply a scan output to second gate lines of the second screen block,
wherein the first screen block comprises a first high frequency region where first image data is updated at a first data refresh rate, and a first low frequency region where second image data is updated at a second data refresh rate which is less than the first data refresh rate, and
wherein the second screen block comprises a second high frequency region where third image data is updated at a third data refresh rate, and a second low frequency region where fourth image data is updated at a fourth data refresh rate which is less than the third data refresh rate.

2. The display apparatus of claim 1, wherein, in a same frame,
a scan output timing corresponding to gate lines of the first high frequency region is earlier than a scan output timing corresponding to gate lines of the first low frequency region, and
a scan output timing corresponding to gate lines of the second high frequency region is earlier than a scan output timing corresponding to gate lines of the second low frequency region.

3. The display apparatus of claim 2, wherein, in a predetermined time,
a number of scan output maskings on the gate lines of the first low frequency region is more than a number of scan output maskings on the gate lines of the first high frequency region, and
a number of scan output maskings on the gate lines of the second low frequency region is more than a number of scan output maskings on the gate lines of the second high frequency region.

4. The display apparatus of claim 1, wherein the first gate driving circuit comprises:
a (4k-3)^{th} gate stage configured to generate a scan output corresponding to a first odd clock, where k is a positive integer; and
a (4k-2)^{th} gate stage configured to generate a scan output corresponding to a second odd clock having a phase which differs from a phase of the first odd clock.

5. The display apparatus of claim 4, wherein the first gate driving circuit further comprises:
a (4k-1)^{th} gate stage configured to generate a scan output corresponding to a first even clock having the same phase as the phase of the first odd clock; and
a 4k^{th} gate stage configured to generate a scan output corresponding to a second even clock having the same phase as the phase of the second odd clock, and
wherein at least one of the first odd clock, the first even clock, the second odd clock, and the second even clock has a clock masking period in at least one predetermined frame.

6. The display apparatus of claim 5, further comprising a plurality of first carry transfer switches configured to be enabled in only forward carry shift driving,
wherein each of the plurality of first carry transfer switches is connected:
between a scan output of the (4k-3)^{th} gate stage and a forward carry input of the (4k-2)^{th} gate stage, or
between a scan output of the (4k-2)^{th} gate stage and a forward carry input of the (4k-1)^{th} gate stage, or
between a scan output of the (4k-1)^{th} gate stage and a forward carry input of the 4k^{th} gate stage.

7. The display apparatus of claim 5, further comprising a plurality of second carry transfer switches configured to be enabled in only reverse carry shift driving,
wherein each of the plurality of second carry transfer switches is connected:
between a scan output of the 4k^{th} gate stage and a reverse carry input of the (4k-1)^{th} gate stage, or
between a scan output of the (4k-1)^{th} gate stage and a reverse carry input of the (4k-2)^{th} gate stage, or
between a scan output of the (4k-2)^{th} gate stage and a reverse carry input of the (4k-3)^{th} gate stage.

8. The display apparatus of claim 1, wherein the second gate driving circuit comprises:
a (4k-3)^{th} gate stage configured to generate a scan output corresponding to a first odd clock, where k is a positive integer; and
a (4k-2)^{th} gate stage configured to generate a scan output corresponding to a second odd clock having a phase which is later than a phase of the first odd clock.

9. The display apparatus of claim 8, wherein the second gate driving circuit further comprises:
a (4k-1)^{th} gate stage configured to generate a scan output corresponding to a first even clock having the same phase as the phase of the first odd clock; and
a 4k^{th} gate stage configured to generate a scan output corresponding to a second even clock having the same phase as the phase of the second odd clock, and
wherein at least one of the first odd clock, the first even clock, the second odd clock, and the second even clock has a clock masking period in at least one predetermined frame.

10. The display apparatus of claim 9, further comprising a plurality of first carry transfer switches configured to be enabled in only forward carry shift driving,
wherein each of the plurality of first carry transfer switches is connected:
between a scan output of the (4k-3)^{th} gate stage and a forward carry input of the (4k-2)^{th} gate stage, or
between a scan output of the (4k-2)^{th} gate stage and a forward carry input of the (4k-1)^{th} gate stage, or
between a scan output of the (4k-1)^{th} gate stage and a forward carry input of the 4k^{th} gate stage.

11. The display apparatus of claim 9, further comprising a plurality of second carry transfer switches configured to be enabled in only reverse carry shift driving,
wherein each of the plurality of second carry transfer switches is connected:
between a scan output of the 4k^{th} gate stage and a reverse carry input of the (4k-1)^{th} gate stage, or
between a scan output of the (4k-1)^{th} gate stage and a reverse carry input of the (4k-2)^{th} gate stage, or
between a scan output of the (4k-2)^{th} gate stage and a reverse carry input of the (4k-3)^{th} gate stage.

12. The display apparatus of claim 1, further comprising a clock masking control circuit configured to:
generate a first control signal corresponding to a scan output masking timing of the first high frequency region and a second control signal corresponding to a scan output masking timing of the first low frequency region, based on first image data to be input to the first screen block, and
generate a third control signal corresponding to a scan output masking timing of the second high frequency region and a fourth control signal corresponding to a scan output masking timing of the second low frequency region, based on second image data to be input to the second screen block.

13. The display apparatus of claim 1, wherein the first gate lines of the first screen block and the second gate lines of the second screen block are electrically disconnected from each other.

14. The display apparatus of claim 1, further comprising:
a first data driving circuit configured to supply first image data to first data lines of the first screen block; and
a second data driving circuit configured to supply second image data to second data lines of the second screen block,
wherein the first data lines and the second data lines are electrically disconnected from each other.

15. The display apparatus of claim 1, wherein the first screen block and the second screen block contact each other with a boundary therebetween.

16. A display apparatus comprising:
a display panel including a first screen block and a second screen block;
a first gate driving circuit configured to supply a scan output to first gate lines of the first screen block; and
a second gate driving circuit configured to supply a scan output to second gate lines of the second screen block,
wherein the first screen block and the second screen block are driven by the first gate driving circuit and the second gate driving circuit at independent data refresh rates.

17. The display apparatus of claim 16, further comprising:
a first data driving circuit configured to supply first image data to first data lines of the first screen block; and
a second data driving circuit configured to supply second image data to second data lines of the second screen block,
wherein the first data lines and the second data lines are electrically disconnected from each other.

18. A driving method of a display apparatus including a first screen block and a second screen block, the driving method comprising:
supplying a scan output to first gate lines of the first screen block; and
supplying a scan output to second gate lines of the second screen block,
wherein the first screen block comprises a first high frequency region where first image data is updated at a first data refresh rate, and a first low frequency region where second image data is updated at a second data refresh rate which is less than the first data refresh rate, and
wherein the second screen block comprises a second high frequency region where third image data is updated at a third data refresh rate, and a second low frequency region where fourth image data is updated at a fourth data refresh rate which is less than the third data refresh rate.

19. The driving method of claim 18, wherein, in a same frame,
a scan output timing corresponding to gate lines of the first high frequency region is earlier than a scan output timing corresponding to gate lines of the first low frequency region, and
a scan output timing corresponding to gate lines of the second high frequency region is earlier than a scan output timing corresponding to gate lines of the second low frequency region.

20. The driving method of claim 19, wherein, in a predetermined time,
a number of scan output maskings on the gate lines of the first low frequency region is more than a number of scan output maskings on the gate lines of the first high frequency region, and
a number of scan output maskings on the gate lines of the second low frequency region is more than a number of scan output maskings on the gate lines of the second high frequency region.
